(19) United States
(12) Patent Application Publication
(10) Pub. No.: US 2005/0210400 A1
(43) Pub. Date: Sep. 22, 2005

(54) Controlling display screen legibility

(76) Inventor: Peter Hoe-Richardson, Chestnut Hill, MA (US)

Correspondence Address: TESTA, HURWITZ & THIBEAULT, LLP, HIGH STREET TOWER, 125 HIGH STREET, BOSTON, MA, 02110, US

(21) Appl. No.: 10/882,552

(22) Filed: Jul. 1, 2004

Related U.S. Application Data
(60) Provisional application No. 60/554,889, filed on Mar. 19, 2004.

(51) Int. Cl. G06F 17/00

(52) U.S. Cl. 715/768; 715/794

(57) ABSTRACT

Computer screen legibility is controlled. A logically topmost software window of a particular color and of a certain transparency is created. The window allows screen objects logically beneath it on a z-axis to be viewed and manipulated and the window reduces a contrast of screen objects logically beneath it on the z-axis.

### CROSS-REFERENCE TO RELATED APPLICATIONS

This application claims priority to, and the benefits of, U.S. Provisional Patent Application Ser. No. 60/554,889 filed Mar. 19, 2004, which is hereby incorporated by reference in its entirety.

### FIELD OF THE INVENTION

The invention relates to controlling display screen legibility.

### BACKGROUND INFORMATION

In today's mobile information technology environment (e.g., computing or consumer electronics environment), individuals need to guard their privacy against information thieves, hackers, and even just the curious snoop passing by. No longer are address books left at home, or company secrets stored in a drawer at the office; they are carried with the individual as they move from home to work and to all points in-between. Various methods, from file level encryption to power-on passwords, have been employed to secure documents stored on laptop computers. Little is available, however, to protect the mobile user from visual “eavesdropping.” Oftentimes employees find themselves checking e-mail or working in common areas such as airports or coffee shops. In these areas, passers-by or people at the next table may have a clear view of an employee's screen. Depending on various factors such as available light and the angle of view, an unprotected laptop screen may be readable, unbeknownst to the employee, from the side or from over her shoulder, even up to several feet away.

Companies such as 3M sell physical filters that are placed over a computer screen to prevent unwanted viewing. These screens filter out light that is emanating at an angle and only allow out light that is emanating perpendicular to the plane of the screen. The 3M screen in particular utilizes a technology similar to venetian blinds to prevent errant light from escaping at an undesired angle. Therefore, the light representing what is on the screen does not emit at a non-perpendicular angle and is not easily viewed from the side. While this helps prevent others from viewing screen content off-center, it does not solve the problem of unintended viewing from a direct orientation at a distance. Physical screens also require the employee to lug around another piece of hardware and place the onus of implementing security on the user. If the employee finds the device cumbersome or clumsy, the likelihood that it will be used, and used consistently, is diminished.

Applications such as WinAmp and Actual Transparent Windows by Actual Tools utilize transparent application window functionality to allow a user to view applications beneath the window of the topmost application window.

### SUMMARY OF THE INVENTION

In accordance with at least one aspect of the invention, screen obscurity that is easy-to-use and hard to defeat is provided. The limitations of physical screens are avoided while a satisfactory screen obfuscation is provided with respect to multiple viewing angles and distances.

In accordance with at least one embodiment of the present invention, a method of controlling computer screen legibility is provided. The method comprises creating a logically topmost software window of a particular color and of a certain transparency, wherein the window allows screen objects logically beneath it on a z-axis to be viewed and manipulated; and the window reduces a contrast of screen objects logically beneath it on the z-axis.

The embodiment is described using a laptop computer, e.g., having a liquid crystal based display, but the technique works with CRT technology and display and computer screens in general, and does not rely on a specific screen technology.

In at least one embodiment of the invention, mobile security and, privacy is improved while the clumsiness and at least some of the other disadvantages of a physical filter screen are avoided. At least one embodiment of the invention includes a contrast ratio adjuster and screen filter implemented entirely in software. Whereas physical filters polarize the light emanating from a screen, an embodiment of the present invention reduces the contrast between the dark and light areas of the screen to prevent unintended viewing. At least one embodiment of the present invention works by adjusting the contrast of what is displayed on the screen.

At least one embodiment of the present invention uses a combination of functions of the Windows operating system to create a semi-opaque, colored filter over the entire screen. Several colors are available as defaults. For example, in one embodiment, the filter is a red color. Both opacity and color are adjustable to suit the user's taste or to meet an employer's security guidelines. These values are used in conjunction with a combination of window creation techniques to achieve the desired result.

While the present invention will be described in connection with a preferred embodiment thereof, it will be understood that it is not intended to limit the invention to that embodiment. On the contrary, it is intended to cover all alternatives, modifications, and equivalents as may be included within the spirit and scope of the invention as defined by the appended claims. Other aspects and advantages of the present invention will become apparent from the following detailed description, taken in conjunction with the accompanying drawings, illustrating the principles of the invention by way of example only.

### BRIEF DESCRIPTION OF THE DRAWINGS

The foregoing and other features and advantages of the present invention, as well as the invention itself, will be more fully understood from the following description of various embodiments, when read together with the accompanying drawings, in which:

FIG. 1 is a flowchart depicting a program for allowing a user to create a semi-opaque, colorized filter for a computer screen using only software in accordance with an embodiment of the invention;

FIG. 2 is a flowchart depicting a method for instantiating a colorized, semi-opaque shade on a computer screen in accordance with an embodiment of the invention;

FIG. 3 is an illustration of a side view of application windows logically layered on a desktop with an embodiment of the invention generally topmost on the z-axis;

FIG. 4 is an illustration of a laptop computer viewed from the front while an embodiment of the present invention is not running;

FIG. 5 is an illustration of the laptop computer of FIG. 4 viewed from the front while an embodiment of the present invention is running;

FIG. 6 is an illustration of the laptop computer of FIG. 4 viewed from an angle while an embodiment of the present invention is not running;

FIG. 7 is an illustration of the laptop computer of FIG. 4 viewed from an angle while an embodiment of the present invention is running;

FIG. 8 is a view of a settings dialog in accordance with one embodiment of the present invention; and

FIG. 9 is a view of a system tray menu running in an exemplary Windows 2000 environment.

### DETAILED DESCRIPTION

Computer screens have a readability limit known as “fall off” due the to method employed by the screen to display data. The fall off of a liquid crystal display (LCD) is typically higher than that of a CRT. This is due to the angle the liquid crystals align to when emitting light. The light emitted from a LCD is projected in a plane generally perpendicular to the screen. When viewed from the side, laptop screens are typically harder to read than CRTs because less light is being directed to an angled viewer. With less light being directed to the angled viewer, the need for a large contrast between background and foreground data is increased when attempting to maintain readability. At least one embodiment of the present invention takes advantage of this concept in that it decreases the contrast between foreground data and background, dramatically making the screen harder to read, especially from the side.

The contrast between light and dark is what enables a user to discern words or images from background colors. For example, black letters on a white page have a high contrast and are thus very readable. Narrowing the contrast gap between data and background amplifies a computer screen's fall off. This limits the ability of a third-party to make out what is on the screen. For example, dark gray letters on a light gray background are harder to read than black letters on a white background. An embodiment of the invention applies a contrast filter to the desktop of the computer user. By logically overlaying a red filter over a black-text-on-white-background embodiment, the difference in contrast between white, e.g., now light red, and black, e.g., now dark red, is diminished. The lowering of the screen's contrast causes the screen's readability to fall off dramatically when the screen is viewed from the side, e.g., by a third party. In addition, readability from a distance is reduced because as distance from the screen is increased, the two colors, e.g., light red and dark red, visually blend together.

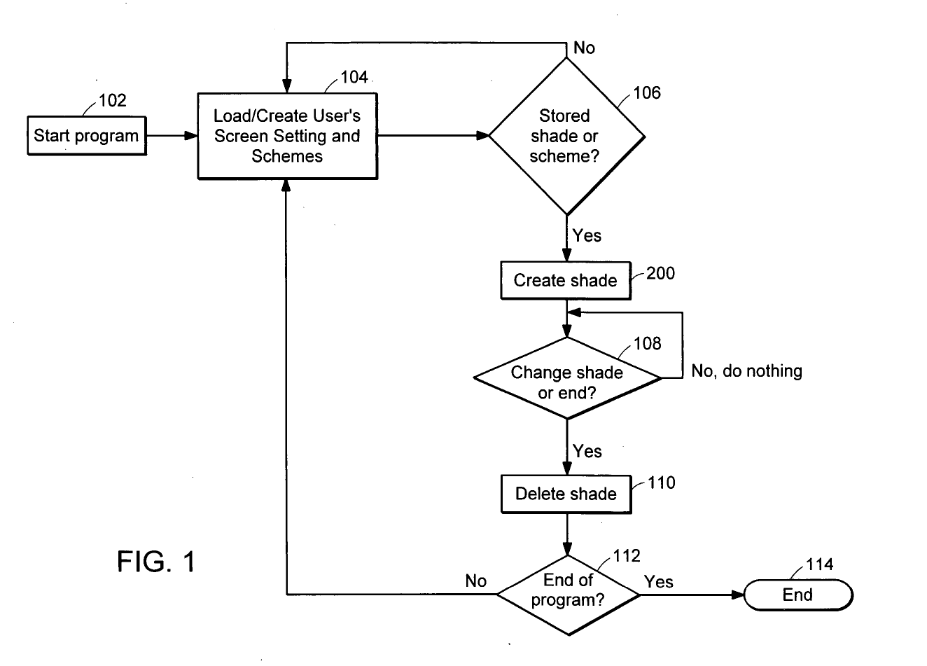

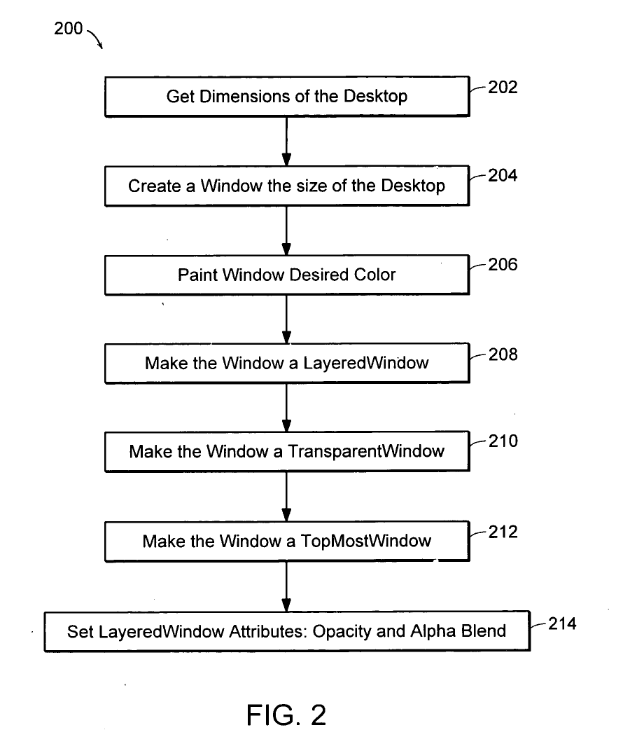

FIG. 1 illustrates an embodiment of the lifecycle of the method. The program is started (step 102) and user preferences are found (step 104), e.g., by being loaded from the program's settings, from default values, from a scheme provided by the user (step 106), or defined interactively through direct user input (step 104). Once the program is finished reading and inputting user preferences, it creates the filter window (“shade”) described in FIG. 2 (step 200). While the user continues to use the existing shade, the program waits for new input (step 108). This waiting does not prevent the user from interacting with other applications or aspects of the operating system or computer. Once the user decides to change an aspect of the shade or end the program (step 108), the program deletes the current shade (step 110). If the user is ending the program (step 112), the program is terminated and the application ends (step 114). In the event of a non-program-terminating change, the method returns to the preference-determining step (step 104) and the cycle is repeated. Upon program shutdown (step 114), the user is able to view the computer screen as normal.

As illustrated in FIG. 2, in at least one implementation, shade creation (FIG. 1, step 200), and thus contrast reduction, is accomplished through a series of sequential steps. In other embodiments, one or more of the steps may be executed in parallel, in a different order, or together with other steps. By use of an aspect of the Windows Application Programming Interface (API), e.g., in at least one embodiment a call to the SystemParametersInfo( ) routine, the size of the user's desktop is calculated (step 202) and a shade is created in accordance with the desktop size (step 204). Though a typical application window covers “available” space on a desktop, this does not usually encompass space used by taskbars and system trays. At least one embodiment of the present invention provides a shade that covers the entire desktop including taskbars and system trays via calculating the screen size and then adding an amount to the calculated window height. In at least one embodiment, the amount is 100 pixels. In other embodiments, only part of the screen is obfuscated, an amount to be determined by the user at runtime (e.g., through an application setting or by changing the shade window size).

In the method, the shade is “painted” a specified color (step 206). In at least one embodiment, the shade uses the Windows API FillRect(rectangle, brush) method call to accomplish this, wherein the brush is a Windows API object that has the specified color as an attribute. The color may be specified through a default value, a pre-defined scheme provided by the user or interactively through direct user input (FIG. 1, steps 104, 106). The shade is then instructed to become a LayeredWindow (step 208). In at least one embodiment, making the shade a LayeredWindow is accomplished by calling the Windows API method SetWindowLongo method and passing in the following parameters: the shade window, a parameter indicating an extended window style will be set, and the “Layered” attribute i.e., WS_EX_LAYERED. The shade being a LayeredWindow allows other application windows and screen objects beneath the shade, such as the task bar, to be viewed, even though the shade may be on top of them. The shade is then instructed to additionally become a TransparentWindow (step 210). Similar to the setting of the LayeredWindow attribute, the shade window is made transparent in at least one embodiment by calling the SetWindowLong( ) method. The first two parameters are the same as previously described, e.g., the shade window and an attribute indicating an extended window style is being set, but in this instance, the third parameter indicates the style to be applied is “Transparent,” i.e., WS_EX_TRANSPARENT. The TransparentWindow allows the shade to pass mouse, keyboard, and other user input to applications beneath the shade (“beneath” is in relation to the shade's z-axis orientation: the higher the z-axis value, the fewer the number of other application windows that are “on top” of the shade).

The shade is then instructed that it is the TopMostWindow (step 212). In at least one embodiment this is accomplished by passing in the extended window style WS_EX_TOPMOST to the window creation method, i.e., CWnd::CreateEx( ). This forces all other application windows to reside beneath the shade. In some embodiments, the shade periodically polls the system to determine if it is still topmost. If at any regular point in time it is not, it instructs itself to be so. In other embodiments, any time another application window becomes topmost, the shade immediately becomes topmost in response. The application still receives user input, but is beneath the shade. Lastly, the shade is then instructed of the shade's opacity and alpha blend values (step 214). These values may be specified through default values, a pre-defined scheme provided by the user, or interactively through direct user input. Additionally, in some embodiments, the API calls may be combined or executed in an order different than listed above.

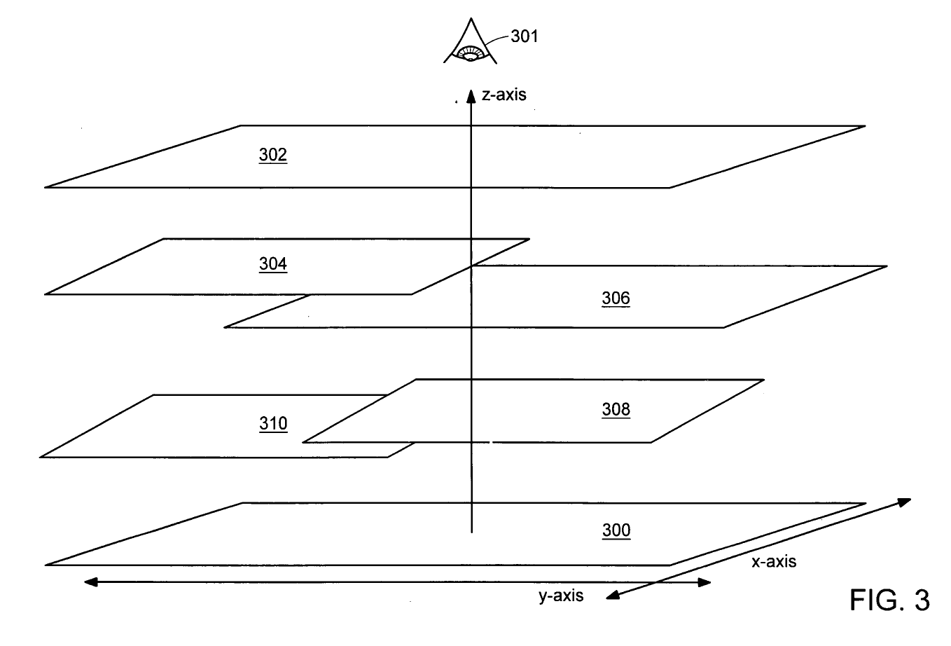

FIG. 3 illustrates the layering of application windows on a “shaded” desktop. The z-axis provided illustrates a positional relationship between the desktop 300 and the user 301. The desktop 300 can be considered to have a z-axis value of zero and the user 301 can be considered to have an infinite z-axis value. Between the two extremes are layers wherein application windows reside, an application with a higher z-axis value being considered closer to the user 301 or “on top” of other applications. In FIG. 3, the shade 302 has a higher z-axis value than the other application windows 304, 306, 308, 310, on the desktop 300. The natural behavior is for an application window, for example 306, to become topmost when it is focused on, e.g., a mouse button is clicked within the xy boundaries of the application window, provided no window (other than the shade) has a higher z-axis value for those xy coordinates. Upon focus, the window's 306 z-axis value normally would be set to the highest of all the windows and it would occupy a z-axis level above them, including the shade 302. However, the shade, through methods described above, maintains its topmost attribute; thus, even if 306 is focused on, at best it may “rise” to a level between the shade 302 and the second highest application window 304.

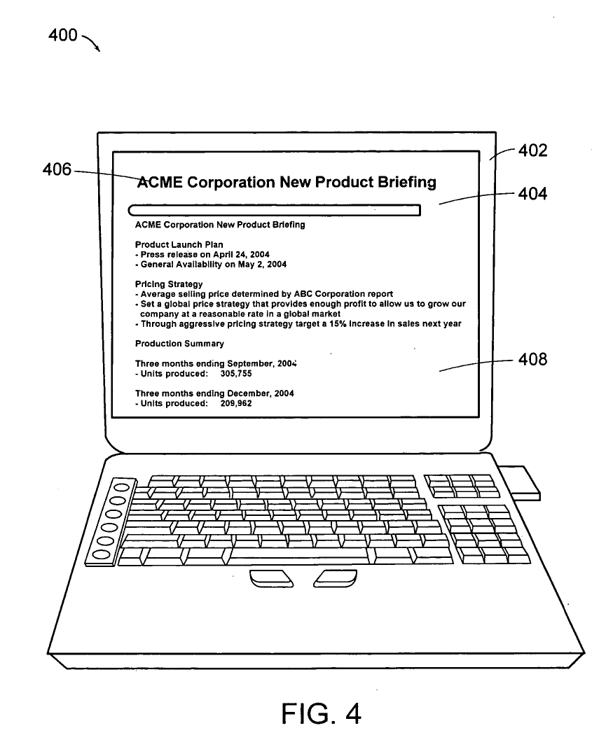

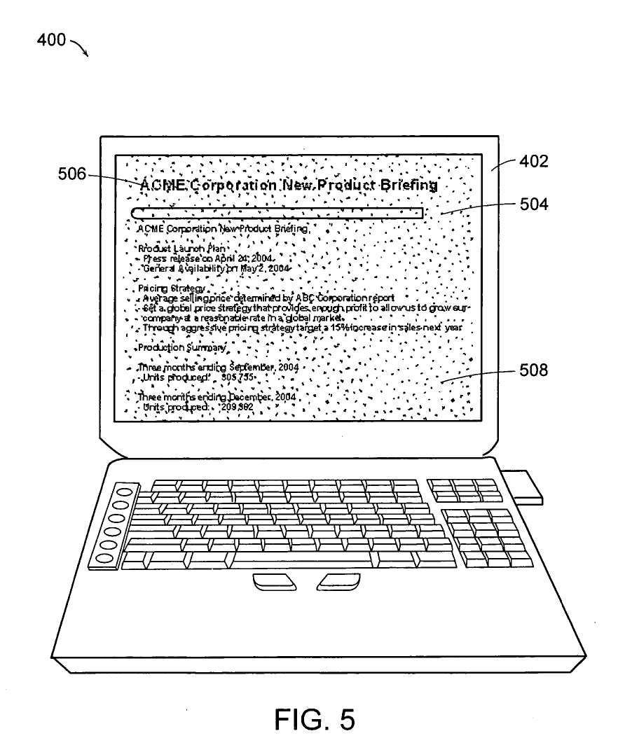

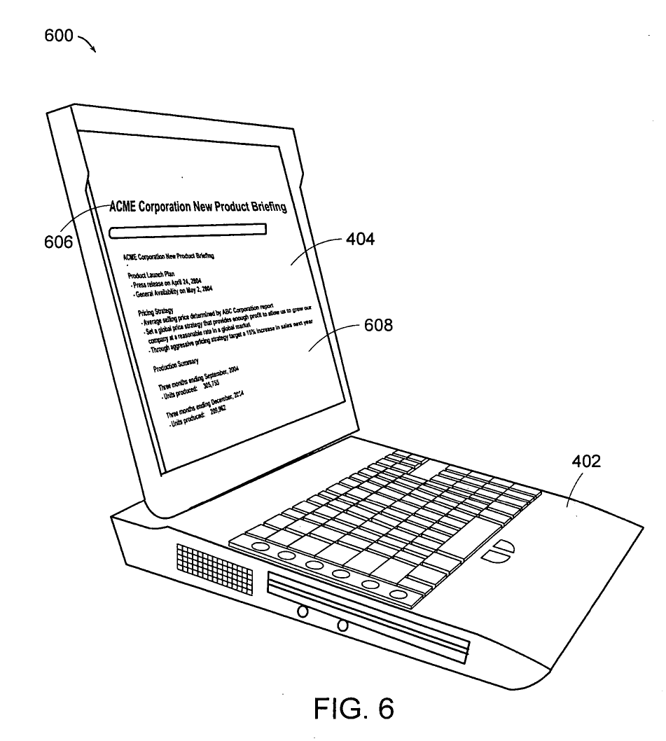

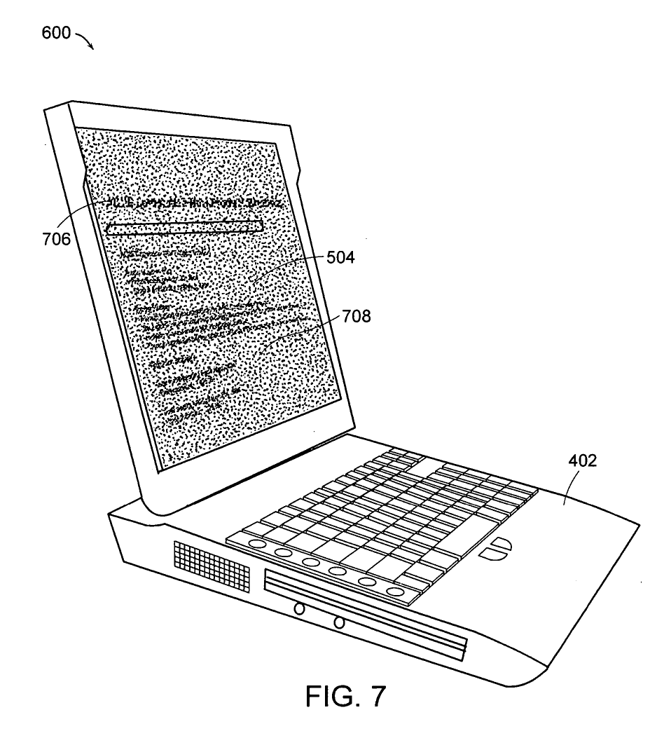

Once the shade is created, the user interacts normally with the computer. FIGS. 4 through 9 demonstrate aspects of the invention. FIG. 4 illustrates a direct orientation 400 with respect to a computer 402, depicting a normal screen 404 (i.e., without a shade being applied). There is a distinguishable contrast between the text 406 and the background 408. FIG. 5 illustrates the same direct orientation 400 with respect to the computer 402 of FIG. 4 but with a shaded screen 504 (i.e., with a shade applied in accordance with one embodiment of the invention). Note that little legibility is lost when viewed at a distance from which a normal user would view the laptop, though a slight reduction in contrast is noticeable between the text 506 and the background 508 (i.e., the screen in FIG. 4 appears “brighter” than the screen with the shade applied in FIG. 5). FIG. 6 is a side view 600 of the computer 402 and screen 404 of FIG. 4, wherein the shade is not running and again, a distinguishable contrast is found between the text 606 and the background 608. FIG. 7 is the same side view 600 as FIG. 6, but now the computer 402 has a shaded screen 504 with the shade applied in accordance with one embodiment of the invention. Note that the screen content, e.g., text 706 and background 708, is obfuscated significantly.

Because the user in direct orientation 400 with the computer screen views the screen as depicted in FIG. 5, input intended for other applications is still able to be transmitted to the respective existing applications, and applications may be opened or closed. The only difference in user-computer interaction is, because all applications are behind the shade, that the user sees a slightly reduced contrast version of the screen when directly oriented at a normal distance (400 in FIGS. 4 and 5). However, when viewing from the side (side view 600 in FIGS. 6 and 7) a third-party observer generally sees a blur of the shade color (FIG. 7) because the contrast between text 706, or any displayed data for that matter, and background 708 has been narrowed. An observer with a direct orientation viewing from a distance sees a blur similar to that illustrated in FIG. 7 because the shade causes data and background to blend together as the distance between screen and observer increases.

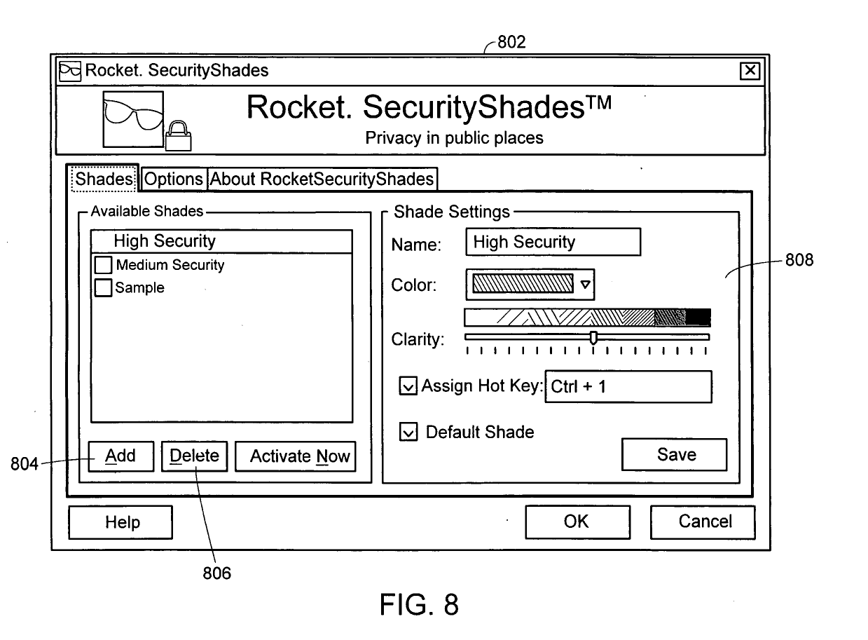

FIG. 8 is an exemplary picture of a Windows 2000 settings dialog box 802 where users can add 804, delete 806, and edit filter shade settings 808.

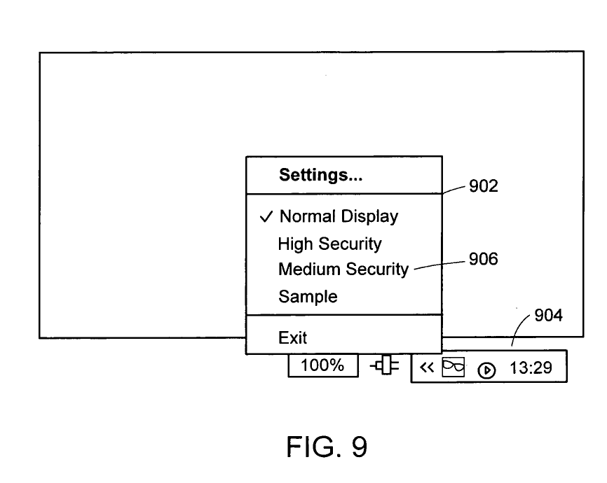

FIG. 9 is an exemplary picture of one embodiment of the invention 902 running in a Windows 2000 system tray 904, allowing access to filter settings 906 without the need to access a menu on shade window.

Though Windows 2000 is used throughout as an example, it should be noted that alternate embodiments of the invention run on, but are not limited to, any Windows platform, e.g., Windows 95, Windows 98, Windows Me, Windows NT, Windows XP, Windows “Longhorn” or other derivations and embodiments of Microsoft's Windows-brand Operating System. Beneficially, embodiments of the present invention that also run on Macintosh platforms, e.g., OS 9 or OS X, or on Unix-like environment such as Linux, FreeBSD, NetBSD, or OpenBSD, are covered within the scope of the essential characteristics and spirit of the invention. Additionally, methods that access video card drivers to overlay the transparent, colorized shade or methods that involve passing messages, different than the examples provided in reference to Windows 2000, to the operating system to accomplish the shade are also contemplated and covered within the scope and spirit of the invention.

From the foregoing, it will be appreciated that the systems and methods provided by the invention afford protection from third-party viewing and overcome the cumbersome nature and disadvantages of physical screen filters.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

1. A method of controlling computer screen legibility, the method comprising:
creating a logically topmost software window of a particular color and of a certain transparency, wherein:
the window allows screen objects logically beneath it on a z-axis to be viewed and manipulated; and
the window reduces a contrast of screen objects logically beneath it on the z-axis.

2. The method of claim 1 wherein the certain transparency is chosen by a user.

3. The method of claim 1 wherein the certain transparency is a default.

4. The method of claim 1 wherein the certain transparency is set by a scheme.

5. The method of claim 1 wherein the particular color is chosen by a user.

6. The method of claim 1 wherein the particular color is a default.

7. The method of claim 1 wherein the particular color is set by a scheme.

8. The method of claim 1 wherein the logically topmost software window covers an area of an entire screen.

9. The method of claim 1 wherein the logically topmost software window covers an area smaller than an area of an entire screen.

10. The method of claim 1 wherein the logically topmost software window covers an area of an application window.

11. Computer software, residing on a computer-readable storage medium, comprising a set of instructions for use in a computer system to cause the computer to:
create a logically topmost software window of a particular color and of a certain transparency;
allow screen objects logically beneath the window on a z-axis to be viewed and manipulated; and
reduce a contrast of screen objects logically beneath the window on the z-axis.

12. The software of claim 111 wherein the certain transparency is selectable by a user of the software.

13. The software of claim 11 wherein the certain transparency has a default value.

14. The software of claim 11 wherein the certain transparency is set by a scheme.

15. The software of claim 11 wherein the particular color is selectable by a user of the software.

16. The software of claim 11 wherein the particular color has a default value.

17. The software of claim 11 wherein the particular color is set by a scheme.

18. The software of claim 11 wherein the logically topmost software window covers an area of an entire screen.

19. The software of claim 11 wherein the logically topmost software window covers an area smaller than an area of an entire screen.

20. The software of claim 11 wherein the logically topmost software window covers an area of an application window.

21. A system for controlling display screen legibility, the system comprising:
a display screen;
first software that provides a graphical user interface to a user via the display screen; and
second software that creates a window of a certain transparency and a particular color, the window overlaying the graphical user interface, wherein the window reduces the contrast of the graphical user interface; thereby obscuring the graphical user interface for a person with an undesired orientation to the display screen.

22. The system of claim 21 wherein the undesired orientation comprises a non-perpendicular orientation in relation to the horizontal or vertical plane of the display screen.

23. The system of claim 21 wherein the undesired orientation comprises an orientation of approximately four or more feet away from the display screen.

24. The system of claim 21 wherein the certain transparency is selectable by a user of the system.

25. The system of claim 21 wherein the certain transparency has a default value.

26. The system of claim 21 wherein the certain transparency is set by a scheme.

27. The system of claim 21 wherein the particular color is selectable by a user of the system.

28. The system of claim 21 wherein the particular color has a default value.

29. The system of claim 21 wherein the particular color is set by a scheme.

30. The system of claim 21 wherein the window covers an area of the entire display screen.

31. The system of claim 21 wherein the window covers an area smaller than an area of the entire display screen.

32. The system of claim 21 wherein the window covers an area of an application window within the graphical user interface.

33. An apparatus for controlling computer screen legibility, the apparatus comprising:
means for creating a logically topmost software window of a particular color and of a certain transparency;
means for allowing screen objects logically beneath the window on a z-axis to be viewed and manipulated; and
means for reducing a contrast of screen objects logically beneath the window on the z-axis.
